(19) United States
(12) Patent Application Publication
(10) Pub. No.: US 2025/0163802 A1
(43) Pub. Date: May 22, 2025

(54) SYSTEM AND METHOD FOR DATA-DRIVEN HYDROCARBON FLUID PROPERTY PREDICTION USING PHYSICS-BASED AND CORRELATION MODELS

(71) Applicant: SAUDI ARABIAN OIL COMPANY, Dhahran (SA)

(72) Inventors: Ahmed H. Al Ayesh, Dhahran (SA); David Echeverría Ciaurri, Dhahran (SA); Mohammed A. Shahri, Dhahran (SA)

(73) Assignee: SAUDI ARABIAN OIL COMPANY, Dhahran (SA)

(21) Appl. No.: 18/516,033

(22) Filed: Nov. 21, 2023

(51) Int. Cl. E21B 49/08; E21B 44/00

(52) U.S. Cl. CPC E21B 49/0875; E21B 44/00; E21B 2200/22

(57) ABSTRACT

Examples of methods and systems are disclosed. The methods may include training a predictor by obtaining, using a laboratory fluid properties analysis system and using physics-based and/or empirical-correlation models, a fluid properties dataset at multiple temperature and pressure conditions. The methods may also include segregating the plurality of data vectors into a plurality of segregated training subsets and forming a set of trained sub-predictors, by training each sub-predictor to predict an output data vector from an input data vector. The methods may further include forming a trained predictor, trained to predict a high-fidelity estimate of an output data vector from an input data vector, by combining each member of the set of trained sub-predictors.

### BACKGROUND

Understanding fluid properties of hydrocarbons in a wellbore under reservoir conditions is important to oilfield operations. Having the ability to accurately predict how downhole fluids behave facilitates successful reservoir evaluation, forecasting, and well operations. Typically, reservoir fluid properties are measured in laboratories and presented in pressure-volume-temperature (PVT) studies to determine how hydrocarbons behave under various conditions. However, high-pressure, high-temperature equipment and skilled personnel are required to carry out such experiments. The process is also time-consuming and expensive. Therefore, it is desirable to have a way to accurately predict reservoir fluid properties at conditions present in the wellbore without having to recreate such conditions in the laboratory.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a computer-implemented method of training a predictor to predict hydrocarbon-fluid properties. The computer-implemented method includes obtaining, using a laboratory fluid properties analysis system and using physics-based models, a fluid properties dataset, where the fluid properties dataset includes a plurality of data vectors. Some data vectors are designated as inputs and some data vectors are designated as outputs and each data vector includes fluid properties at one temperature and pressure condition. The method further includes segregating the plurality of data vectors into a plurality of segregated training subsets, forming a set of trained sub-predictors, by training each sub-predictor to predict an output data vector from an input data vector, where each sub-predictor is trained using one segregated training subset. The method further includes forming a trained predictor, trained to predict a high-fidelity estimate of an output data vector from an input data vector, by combining each member of the set of trained sub-predictors.

In another aspect, embodiments disclosed herein relate to a method for predicting hydrocarbon-fluid properties at desired conditions, including obtaining, using a well logging tool, an input data vector, where the input data vector comprises reservoir conditions pertaining to an application hydrocarbon reservoir. The method further includes determining, using a trained predictor, fluid properties of a fluid at desired conditions pertaining to the application hydrocarbon reservoir from the input data vector and using estimations of fluid properties obtained from physics-based models.

In yet another aspect, embodiments disclosed herein relate to a system including a well logging tool, configured to measure reservoir conditions pertaining to an application hydrocarbon reservoir and a laboratory fluid properties analysis system, configured to measure an application dataset pertaining to the application hydrocarbon reservoir, where the application dataset includes reservoir fluid properties at multiple temperature and pressure conditions. The system also includes a trained predictor, configured to determine fluid properties of a fluid sample at desired conditions pertaining to the application hydrocarbon reservoir from a fluid properties dataset, where the fluid properties dataset includes a plurality of data vectors, where some data vectors are designated as inputs and some data vectors are designated as outputs, and each data vector including fluid properties at one temperature and pressure condition obtained using a laboratory fluid properties analysis system and using physics-based models. The system also includes a reservoir simulator, configured to simulate a fluid flow within the application hydrocarbon reservoir and identify a drilling target based, at least in part, on the simulated fluid flow. The system further includes a wellbore planning system, configured to plan a planned wellbore trajectory to reach the drilling target and a drilling system, configured to drill a wellbore guided by the planned wellbore trajectory.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

Specific embodiments of the disclosure will now be described in detail withreference to the accompanying figures. Like elements in the various figures are denoted by like reference numerals for consistency.

FIG. 1 shows a depiction of a machine-learning network.

FIG. 2 shows an example laboratory fluid properties analysis system.

FIG. 3 shows a flowchart related to a process for planning a well in accordance with one or more embodiments.

FIGS. 4A and 4B show a reservoir simulator in accordance with one or more embodiments.

FIG. 5 shows a drilling rig in accordance with one or more embodiments.

FIG. 6 shows a training workflow in accordance with one or more embodiments.

FIG. 7 shows a prediction workflow in accordance with one or more embodiments.

FIG. 8 shows a training workflow with data segregation and correlation models in accordance with one or more embodiments.

FIG. 9 shows a prediction workflow with data segregation and correlation models in accordance with one or more embodiments.

FIG. 10 depicts a flowchart in accordance with the one or more embodiments.

FIG. 11 depicts a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope of the invention should not be considered limited to the specific arrangement of steps shown in the flowcharts.

Although multiply dependent claims are not introduced, it would be apparent to one of ordinary skill that the subject matter of the dependent claims of one or more embodiments may be combined with other dependent claims.

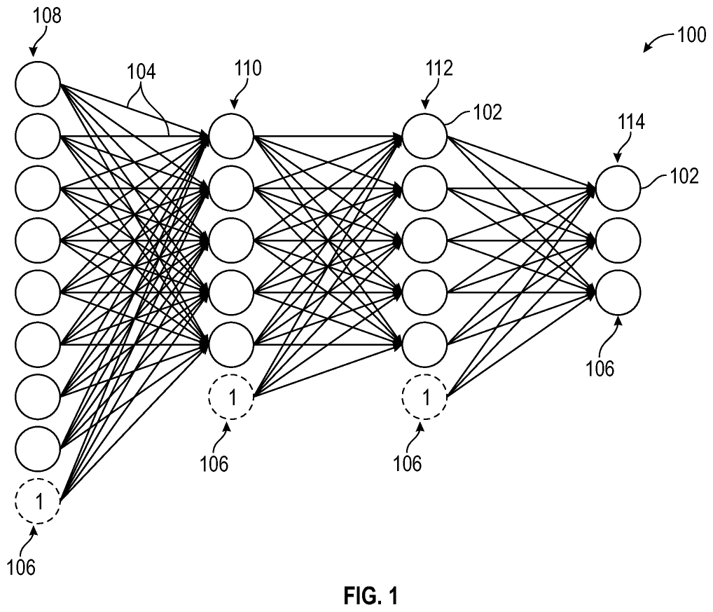

In the following description of FIGS. 1-11, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Disclosed herein are systems and methods to predict hydrocarbon fluid properties at reservoir conditions using a data-based framework where multiple predictive machine-learning (ML) models, can be combined. Embodiments of the disclosed methodology combine empirical correlations with physics-based simulations and compositional analysis databases as input data to improve prediction accuracy. Because a predictor is trained/calibrated to predict hydrocarbon fluid properties, the expense and difficulty of PVT laboratory measurements is avoided.

### Predictor

One or more embodiments relate to estimating hydrocarbon fluid properties using a previously calibrated data-based predictor. One or more embodiments further relates to predicting hydrocarbon fluid properties at multiple conditions, for example reservoir conditions, from hydrocarbon fluid properties obtained in a laboratory at multiple conditions, for example standard temperature and pressure, using the trained predictor.

Machine learning (ML), broadly defined, is the extraction of patterns and insights from data. The phrases “artificial intelligence,” “machine learning,” and “deep learning” are often interchanged and used synonymously. This ambiguity arises because the field of “extracting patterns and insights from data” was developed simultaneously and disjointedly among a number of classical arts like mathematics, statistics, and computer science. For consistency, the term machine learning will be adopted herein. However, one skilled in the art will recognize that the concepts and methods detailed hereafter are not limited by this choice of nomenclature.

In some embodiments, the predictor may be a neural network (NN). In another embodiment, more suited to scenarios where components of the data have significant spatial or temporal relationship, the predictor may be a recurrent neural network (RCNN), such as the Pixel convolutional neural network (PixelCNN). An RCNN may be more readily understood as a specialized convolutional neural network (CNN) and, from there, as a specialized NN. Thus, a cursory introduction to NNs and CNNs is provided herein. However, note that many variations of an NN exist. Therefore, one of ordinary skill in the art will recognize that any variation of an NN (or any other network), such as, for example, a Bayesian neural network, may be employed without departing from the scope of this disclosure. Further, the predictor may be based on other machine-learning techniques such as, for example, Gaussian processes. It is emphasized that the following discussion of an NN is a basic summary and should not be considered limiting.

A diagram of an NN is shown in FIG. 1. At a high level, an NN 100 may be graphically depicted as being composed of nodes 102 and edges 104. The nodes 102 may be grouped to form layers 105. FIG. 1 displays four layers 108, 110, 112, 114 of nodes 102 where the nodes 102 are grouped into columns. However, each group need not be as shown in FIG. 1. The edges 104 connect the nodes 102 to other nodes 102. Edges 104 may connect, or not connect, to any node(s) 102 regardless of which layer 105 the node(s) 102 is in. That is, the nodes 102 may be sparsely and residually connected. For example, in an RNN, nodes 102 in the output layer 114 may be connected by edges 104 to nodes 102 in the input layer 108 (though not shown in FIG. 1).

An NN 100 will have at least two layers, where the first layer 108 is the “input layer” and the last layer 114 is the “output layer.” Any intermediate layer 110, 112 is usually described as a “hidden layer.” An NN 100 may have zero or more hidden layers 110, 112. An NN 100 with at least one hidden layer 110, 112 may be described as a “deep” neural network or “deep learning method.” In general, an NN 100 may have more than one node 102 in the output layer 114. In these cases, the NN 100 may be referred to as a “multi-target” or “multi-output” network.

Nodes 102 and edges 104 carry associations. Namely, every edge 104 is associated with a numerical value. The edge numerical values, or even the edges 104 themselves, are often referred to as “weights” or “parameters.” While training an NN 100, a process that will be described below, numerical values are assigned to each edge 104. Additionally, every node 102 is associated with a numerical value and may also be associated with an activation function. Activation functions are not limited to any functional class, but traditionally are a function of the sum of the products of node and edge values for all “incoming” nodes.

Incoming nodes 102 are those that, when viewed as a graph (as in FIG. 1), have directed arrows that point to the node 102 where the numerical value is being computed. Some functions ƒ may include the linear function ƒ(x)=x, sigmoid function ƒ(x)=1/1+e^{-x} and rectified linear unit function ƒ(x)=max(0, x), however, many additional functions are commonly employed. Every node 102 in an NN 100 may have a different associated activation function. Often, as a shorthand, activation functions are described by the function ƒ by which it is composed. That is, an activation function composed of a linear function ƒ may simply be referred to as a linear activation function without undue ambiguity.

When the NN 100 receives an input, the input is propagated through the network according to the activation functions and incoming node values and edge values to compute a value for each node 102. That is, the numerical value for each node 102 may change for each received input while the edge values remain unchanged. Occasionally, nodes 102 are assigned fixed numerical values, such as the value of 1. These fixed nodes 106 are not affected by the input or altered according to edge values and activation functions. Fixed nodes 106 are often referred to as “biases” or “bias nodes” as displayed in FIG. 1 with a dashed circle.

In some implementations, the NN 100 may contain specialized layers, such as a normalization layer, pooling layer, or additional connection procedures, like concatenation. One skilled in the art will appreciate that these alterations do not exceed the scope of this disclosure.

The number of layers in an NN 100, choice of activation functions, inclusion of batch normalization layers, and regularization strength, among others, may be described as “hyperparameters” that are associated with the network. It is noted that in the context of NN, the regularization of a network refers to a penalty applied to the loss function of the network. The selection of hyperparameters associated with the network is commonly referred to as selecting the network “architecture.”

Once a network, such as an NN 100, and associated hyperparameters have been selected, the network may be trained. To do so, M training pairs may be provided to the NN 100, where M is an integer greater than or equal to one. For example, if M=2, the two training pairs include a first training pair and a second training pair each of which may be generically denoted as mth training pair. In general, each of the M training pairs includes an input and an associated target output, and any of these can be a vector. Each associated target output represents the “ground truth,” or the otherwise desired output upon processing the input. During training, the NN 100 processes at least one input from an mth training pair to produce at least one output. Each NN output is then compared to the associated target output from the mth training pair.

Returning to the NN 100 in FIG. 1, the NN 100 may be trained by first assigning initial values to the edges 104. These values may be assigned randomly, according to a prescribed distribution, manually, or by some other assignment mechanism. Once edge values have been initialized, the NN 100 may act as a function such that it may receive an input from an mth training pair and produce an output. At least one input is propagated through the NN 100 to produce an output. The M training pairs will be discussed in more detail below.

The comparison of the NN output to the associated target output from the mth training pair is typically performed by a “loss function.” Other names for this comparison function include an “error function,” “misfit function,” and “cost function.” Many types of loss functions are available, such as the log-likelihood function. However, the general characteristic of a loss function is that the loss function provides a numerical evaluation of the similarity between the NN output and the associated target output from the mth training pair. The loss function may also be constructed to impose additional constraints on the values assumed by the edges 104. For example, a penalty term, which may be physics-based, or a regularization term may be added. Generally, the goal of a training procedure is to alter the edge values to promote similarity between the NN output and associated target output for most, if not all, of the M training pairs. Thus, the loss function is used to guide changes made to the edge values.

While a full review of the backpropagation process exceeds the scope of this disclosure, a brief summary is provided. Backpropagation involves computing the gradient of the loss function over the edge values. The gradient indicates the direction of change in the edge values that results in the greatest change to the loss function. Because the gradient is local to the current edge values, the edge values are typically updated by a “step” in the direction indicated by the gradient. The step size is often referred to as the “learning rate” and need not remain fixed during the training process. Additionally, the step size and direction may be informed by previous edge values or previously computed gradients. Such methods for determining the step direction are usually referred to as “momentum” based methods.

Once the edge values of the NN 100 have been updated through the backpropagation process, the NN 100 will likely produce different outputs than it did previously. Thus, the procedure of propagating at least one input from an mth training pair through the NN 100, comparing the NN output with the associated target output from the mth training pair with a loss function, computing the gradient of the loss function with respect to the edge values, and updating the edge values with a step guided by the gradient is repeated until a termination criterion is reached. Common termination criteria include, but are not limited to, reaching a fixed number of edge updates (otherwise known as an iteration counter), reaching a diminishing learning rate, noting no appreciable change in the loss function between iterations, or reaching a specified performance metric as evaluated on the m training pairs or separate hold-out training pairs (often denoted “validation data”). Once the termination criterion is satisfied, the edge values are no longer altered and the NN 100 is said to be “trained.”

Turning to a CNN, a CNN is similar to an NN 100 in that it can technically be graphically represented by a series of edges 104 and nodes 102 grouped to form layers 105. However, it is more informative to view a CNN as structural groupings of weights. Here, the term “structural” indicates that the weights within a group have a relationship, often a spatial relationship. CNNs are widely applied when the input also has a relationship. For example, the pixels of a seismic image have a spatial relationship where the value associated with each pixel is spatially dependent on the value of other pixels of the seismic image. Consequently, a CNN is a good choice for processing data that includes images and may include other spatially dependent data. As mentioned previously, one of ordinary skill in the art will recognize that any variation of an NN or CNN (or any other network) may be employed without departing from the scope of this disclosure. It is emphasized that the following discussion of an CNN is a basic summary and should not be considered limiting.

A structural grouping of weights is herein referred to as a “filter” or “convolution kernel.” The number of weights in a filter is typically much less than the number of inputs, where now, each input may refer to a pixel in an image. For example, a filter may take the form of a square matrix, such as a 3×3 or 7×7 matrix. In a CNN, each filter can be thought of as “sliding” over, or convolving with, all or a portion of the inputs to form an intermediate output or intermediate representation of the inputs which possess a relationship. The portion of the inputs convolved with the filter may be referred to as a “receptive field.” Like the NN 100, the intermediate outputs are often further processed with an activation function. Many filters of different sizes may be applied to the inputs to form many intermediate representations. Additional filters may be formed to operate on the intermediate representations creating more intermediate representations. This process may be referred to as a “convolutional layer” within the CNN. Multiple convolutional layers may exist within a CNN as prescribed by a user.

There is a “final” group of intermediate representations, wherein no filters act on these intermediate representations. In some instances, the relationship of the final intermediate representations is ablated, which is a process known as “flattening.” The flattened representation may be passed to an NN 100 to produce a final output. Note that, in this context, the NN 100 is considered part of the CNN.

Like a NN 100, a CNN is trained. The filter weights and the edge values of the internal NN 100, if present, are initialized and then determined using the M training pairs and backpropagation as previously described.

Embodiments described herein relate to training a predictor to predict hydrocarbon-fluid properties at multiple conditions from hydrocarbon fluid properties obtained in a laboratory at multiple conditions. For example, multiple conditions may include, but are not limited to, reservoir conditions and standard temperature and pressure. Predicting hydrocarbon-fluid properties may include using a data-based framework where multiple predictive models may be combined.

### Laboratory Fluid Properties Analysis System

In accordance with one or more embodiments, a fluid properties dataset may be required. A fluid properties dataset is used herein to describe a set of data obtained using a laboratory fluid properties analysis system and data pairs obtained using physics-based simulation. In one or more embodiments, the fluid may be a hydrocarbon from a hydrocarbon reservoir. The properties in the fluid properties dataset may include any fluid property of interest, for example, properties of a hydrocarbon fluid such as, without limitation, temperature, pressure, volume, bubble-point pressure, formation volume factor, liquid specific gravity, American Petroleum Institute (API) density, retrograde dewpoint pressure, saturation pressure, critical point, mixture density, stock-tank density, and viscosity. In one or more embodiments, the fluid properties dataset may include multiple data pairs, with each data pair including an input or an output, or multiple data vectors, including input data vectors and output data vectors. Each data pair may include fluid properties at different temperatures and pressures, ranging from fluid properties at standard temperature and pressure, to fluid properties at one or more elevated temperature and pressure, such as the temperature and pressure of a hydrocarbon reservoir (“reservoir conditions”) or even higher than reservoir conditions. In one or more embodiments, the fluid properties dataset may be used to create training datasets used to train a predictor.

In one or more embodiments, a laboratory fluid properties analysis system may include machines and apparatuses to measure pressure-volume-temperature data of reservoir fluid samples. Laboratory fluid properties analysis systems useful to one or more embodiments disclosed herein may include a computer system and a machine or apparatus used to measure physical properties of a hydrocarbon fluid sample. Examples of machines or apparatuses may include any known in the industry, such as a Pressure-Volume cell used to perform a Constant Composition Expansion experiment, a Pressure-Volume cell used to perform a Differential Liberation experiment, a Pressure-Volume cell used to perform a Flash Liberation experiment, a Separator test used to separate oil from gas in the laboratory, Gas Chromatography for compositional analysis, Gel Permeation Chromatography, and the like.

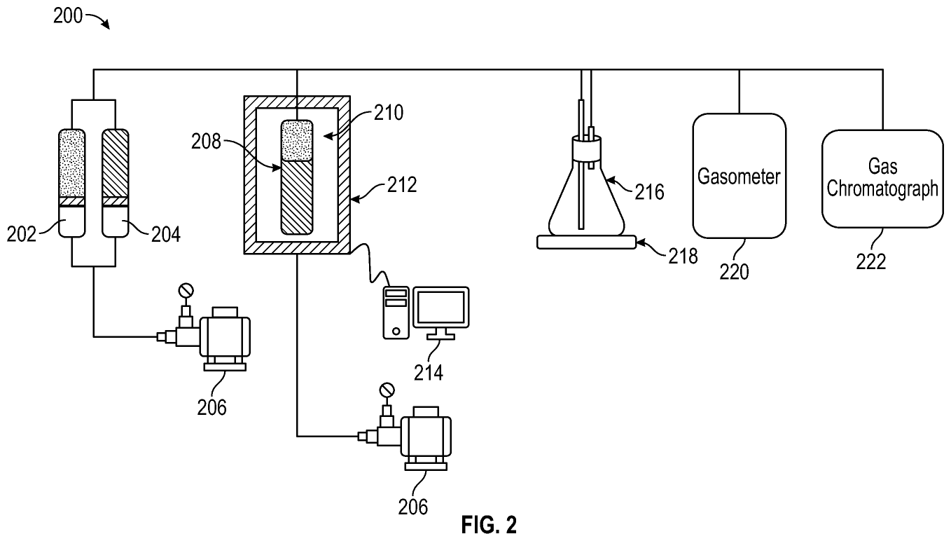

FIG. 2 shows an example laboratory fluid properties analysis system in accordance with one or more embodiments. In general, a laboratory fluid analysis system is used to determine reservoir fluid behavior and properties from gas and oil samples taken from a reservoir. The study of reservoir fluids in the laboratory fluid analysis system may be used to simulate reservoir and surface conditions of a wellbore during production. The laboratory fluid properties analysis system 200 illustrated in FIG. 2 may include a hydrocarbon sample cell 204 and a gas purge cell 202, connected to an automatic pump 206. The hydrocarbon sample cell 204 and the gas purge cell 202 are fluidly connected to a Pressure-Volume (PV) cell 210. The automatic pump 206 may be used to move fluids from the hydrocarbon sample cell 204 and the gas purge cell 202 into a sample cell 208 disposed within the PV cell 210. The temperature within the PV cell 210 may be monitored and controlled using a temperature control system 212 and the pressure of the PV cell may be controlled by a pump 206. A control system 214 may be used to operate systems and machinery of the laboratory fluid properties analysis system. The fluid in the sample cell 208 is then sent to a flash separator 216 which is coupled with an electronic balance 218. The flash separator 216 may be used to collect a liquid condensate sample and a vapor phase may be sent to a gasometer 220 to store the vapor phase, before sending to a further analysis system, for example, the gas chromatograph 222 shown in FIG. 2.

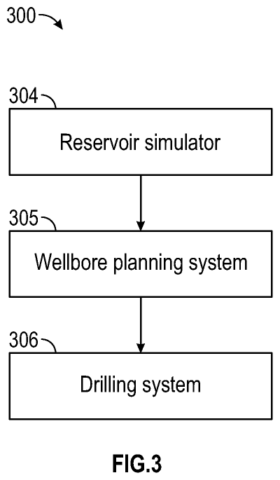

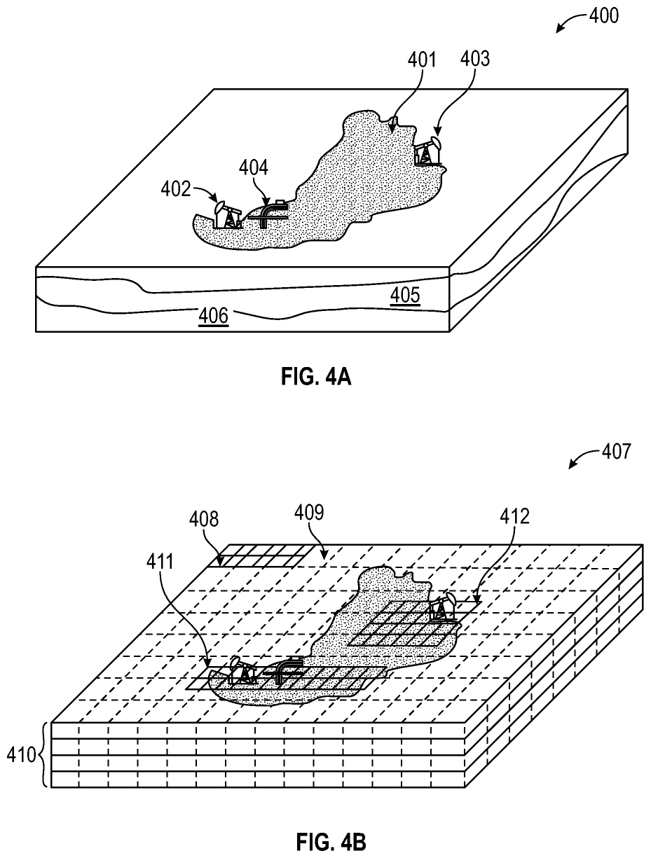

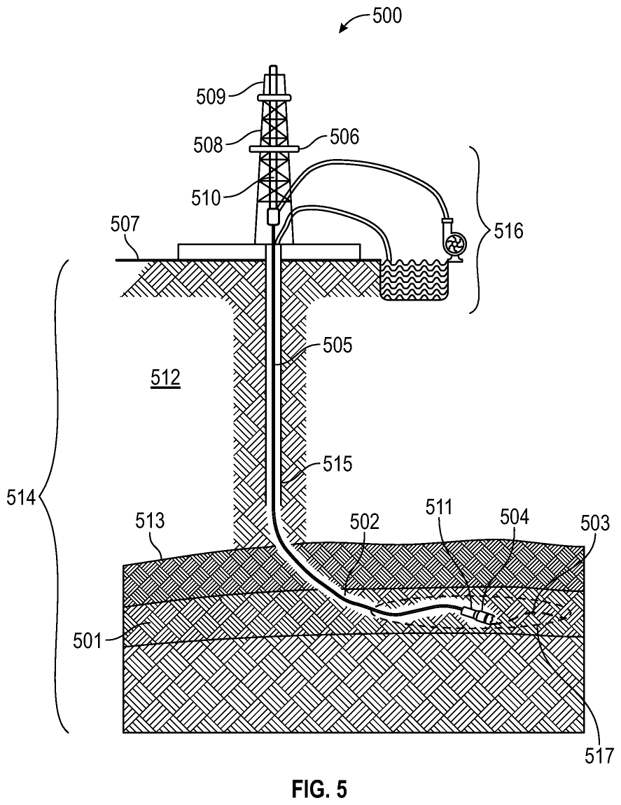

FIG. 3 shows a block diagram of systems 300 in accordance with one or more embodiments. Each system may be coupled to, or exchange information with, one or more other systems within the series of systems 300. A reservoir simulator 304 may be used to simulate a fluid flow within a model of an application hydrocarbon reservoir, such as the reservoir grid model shown in FIG. 4 below. These simulations may provide an understanding of how the application hydrocarbon reservoir responds to various production scenarios, including the drilling of new wells, the installation of production pumps, or the injection of fluids to maintain reservoir pressure and flush or sweep hydrocarbons towards production wells. From this information a drilling target may be identified, and a wellbore planning system 305 may be used to plan a wellbore trajectory 503 to reach a drilling target 517, as shown in FIG. 5 and discussed further below. Each of the reservoir simulator 304 and the wellbore planning system 305 may use one or multiple computers or processors and may employ distributed, edge, or cloud computing. The reservoir simulator 304 and the wellbore planning system 305 also may be functionally combined into a single computing system.

A drilling system 306 may then be used to drill a wellbore guided by the planned wellbore trajectory designed from the wellbore planning system 305. In one or more embodiments, a drilling system may be used to drill a well based on hydrocarbon fluid properties predicted using the machine-learning model described herein. Information obtained from the reservoir simulator 304 may be transferred to the drilling system, which may then drill the wellbore along the planned wellbore path to access and produce the hydrocarbon reservoir 501.

### Reservoir Simulator

One or more embodiments herein relates to a reservoir simulator. The reservoir simulator may be used to simulate a fluid flow within an application hydrocarbon reservoir. From this information a drilling target may be identified, and a wellbore planning system may be used to plan a wellbore trajectory to reach a drilling target. A drilling system may then be used to drill a wellbore guided by the planned wellbore trajectory.

In some embodiments, reservoir simulation may be performed using the estimated reservoir properties for the hydrocarbon reservoir. For example, the reservoir simulator may include hardware and/or software with functionality for generating one or more reservoir models regarding the hydrocarbon-bearing formation and/or performing one or more reservoir simulations. For example, the reservoir simulator may store well logs and data regarding core samples for performing simulations. A reservoir simulator may further analyze the well log data, the core sample data, seismic data, and/or other types of data to generate and/or update the one or more reservoir models.

Turning to FIG. 4A, FIG. 4A shows a schematic diagram in accordance with one or more embodiments. As illustrated in FIG. 4A, FIG. 4A shows a geological region 400 that may include one or more reservoir regions (e.g., reservoir region 401) with various production wells (e.g., production well A 402, production well B 403). Likewise, a reservoir region may also include one or more injection wells (e.g., injection well C 404) that include functionality for enhancing production by one or more neighboring production wells. As shown in FIG. 4A, wells may be disposed in the reservoir region 401 above various subsurface layers (e.g., subsurface layer A 405, subsurface layer B 406), which may include hydrocarbon deposits and unconventional reservoirs. In particular, production data and/or injection data may exist for a particular well, where production data may include data that describes production or production operations at a well, such as fluid properties and compositions of samples taken at the wellhead.

Turning to FIG. 4B, FIG. 4B shows a schematic diagram in accordance with one or more embodiments. As illustrated in FIG. 4B, FIG. 4B shows a reservoir grid model 407 that corresponds to the geological region 400 from FIG. 4A. More specifically, the reservoir grid model 407 includes grid cells 408 that may refer to an original cell of a reservoir grid model as well as coarse grid blocks 409 that may refer to an amalgamation of original cells of the reservoir grid model. For example, a grid cell may be the case of a 1×1 block, where coarse grid blocks may be of sizes 2×2, 4×4, 8×8, etc. Both the grid cells 408 and the coarse grid blocks 409 may correspond to columns for multiple model layers 410 within the reservoir grid model 407.

Prior to performing a reservoir simulation, local grid refinement and coarsening may be used to increase or decrease grid resolution in a certain area of the reservoir grid model. For example, various reservoir properties, e.g., permeability, porosity, or saturations, may correspond to a discrete value that is associated with a particular grid cell or coarse grid block. However, by using discrete values to represent a portion of a geological region, a discretization error may occur in a reservoir simulation. Thus, finer grids may reduce discretization errors as the numerical approximation of a finer grid is closer to the exact solution, however through a higher computational cost. As shown in FIG. 4B, for example, the reservoir grid model 407 may include various fine-grid models (i.e., fine-grid model A 411, fine-grid model B 412), that are surrounded by coarse block regions. Likewise, the original reservoir grid model without any coarsening may also be a fine-grid model.

In some embodiments, proxy models or reduced-order models may be generated for performing a reservoir simulation. For example, one way to reduce model dimensionality is to reduce the number of grid blocks and/or grid cells. By averaging reservoir properties into larger blocks while preserving the flow properties of a reservoir model, computational time of a reservoir simulation may be reduced. In general, coarsening may be applied to cells that do not contribute to a total flow within a reservoir region because a slight change in such reservoir properties may not affect the output of a simulation. Accordingly, different levels of coarsening may be used on different regions of the same reservoir model. As such, a coarsening ratio may correspond to a measure of coarsening efficiency, which may be defined as a total number of cells in a coarse reservoir model divided by the original number of cells in the original reservoir model.

Flow properties, such as flux, may be defined for a reservoir fluid (e.g., oil or natural gas) that flows between any two grid blocks. Likewise, grid cells or blocks may be upscaled in a method that reduces the computational demand on running simulations using fewer grid cells.

In some embodiments, a reservoir simulator comprises functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator may be used to predict changes in fluid flow, including fluid flow into a well penetrating the reservoir as a result of planned well drilling, and fluid injection and extraction. For example, the reservoir simulator may be used to predict changes in hydrocarbon production rate that would result from the injection of water into the reservoir from wells around the reservoir's periphery.

The reservoir simulator may use a reservoir model that contains a digital description of the physical properties of the rocks as a function of position within the reservoir and the fluids within the pores of the porous, permeable reservoir rocks at a given time. In some embodiments, the digital description may be in the form of a dense 3D grid with the physical properties of the rocks and fluids defined at each node. In some embodiments, the 3D grid may be a cartesian grid, while in other embodiments the grid may be an irregular grid.

The physical properties of the rocks and fluids within the reservoir may be obtained from a variety of geological and geophysical sources. For example, remote sensing geophysical surveys, such as seismic surveys, gravity surveys, and active and passive source resistivity surveys, may be employed. In addition, data collected such as well logs, core data, production data as previously discussed, acquired in wells penetrating the reservoir may be used to determine physical and petrophysical properties along the segment of the well trajectory traversing the reservoir. For example, porosity, permeability, density, seismic velocity, and resistivity may be measured along these segments of wellbore. In accordance with some embodiments, remote sensing geophysical surveys and physical and petrophysical properties determined from well logs may be combined to estimate physical and petrophysical properties for the entire reservoir simulation model grid.

Reservoir simulators solve a set of mathematical governing equations that represent the physical laws that govern fluid flow in porous, permeable media. For example, for the flow of a single-phase slightly compressible oil with a constant viscosity and compressibility, the equations that capture Darcy's law, the continuity condition and the equation of state may be written as Equation 1:

$${∇}^{2} p ( x , t ) = \frac{φμ {c}_{t}}{k} \frac{\partial p ( x , t )}{\partial t} , \qquad ( Equation 1 )$$

where p represents fluid pressure in the reservoir, x is a vector representing spatial position and t represents time. The parameters φ, μ, cₜ, and k represent the physical and petrophysical properties of porosity, fluid viscosity, total combined rock and fluid compressibility, and permeability, respectively, and ∇² represents the spatial Laplacian operator.

Additionally, more complicated equations, such as the Peng-Robinson equation of state (EoS), may be required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite-element methods, or discrete Galerkin methods.

In one or more embodiments, physics-based simulations, such as, for example, reservoir simulations, are used to obtain data pairs. The obtained data pairs may be used in a fluid properties dataset and subsequently may be used to create training datasets useful for training a predictor according to embodiments disclosed herein.

### Wellbore Planning System

Knowledge of the existence and location of the hydrocarbon reservoir 501 based on input from the reservoir simulator 304 and other subterranean features may be transferred to a wellbore planning system 305. The wellbore planning system 305 may use information regarding the hydrocarbon reservoir 501 location to plan a well, including a wellbore trajectory 503 from the surface 507 of the earth to penetrate the hydrocarbon reservoir 501. In addition to the depth and geographic location of the hydrocarbon reservoir 501, the planned wellbore trajectory 503 may be constrained by surface limitations, such as suitable locations for the surface position of the wellhead, i.e., the location of potential or preexisting drilling rig, drilling ships or from a natural or man-made island. Along with the wellhead and drilling target locations, a wellbore trajectory may be influenced by shallow drilling hazards, such as gas pockets, subterranean water flows or unstable or metastable fault zones. Further, the wellbore trajectory may be constrained by limitations of the available drilling systems, e.g., by the maximum curvature (“dogleg”) that the drill string may tolerate and the maximum torque and drag that the available drilling system may overcome. A wellbore planning system, composed of one or more computer systems and appropriate wellbore planning software, may be used to plan the wellbore trajectory. The wellbore planning system may further determine planned wellbore caliper changes as a function of depth and the associated placement of casing (“casing points”) to provide mechanical support for the wellbore during and after drilling and the protection of the wellbore from the undesired influx of formation fluids into the wellbore.

Typically, the wellbore plan is generated based on best available information at the time of planning from a geophysical model, geo-mechanical models encapsulating subterranean stress conditions, the trajectory of any existing wellbores (which it may be desirable to avoid), and the existence of other drilling hazards, such as shallow gas pockets, over-pressure zones and active fault planes. The wellbore plan may be updated during the drilling of the wellbore. For example, the wellbore plan may be updated based upon new data about the condition of the drilling equipment and about the subterranean region 514 through which the wellbore is drilled.

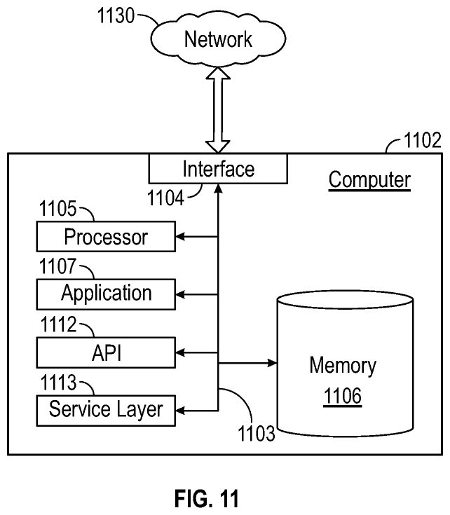

The wellbore planning system 305 may include computer systems, such as the computer system described in FIG. 11, and may further include dedicated software to determine the planned wellbore path and associated drilling parameters, such as the planned wellbore diameter, the location of planned changes of the wellbore diameter, the planned depths at which casing will be inserted to support the wellbore and to prevent formation fluids entering the wellbore, and the drilling mud weights (densities) and types that may be used during drilling the wellbore.

### Drilling System

In accordance with one or more embodiments, a drilling system may be used to drill a wellbore guided by the wellbore trajectory planned using the reservoir simulator as previously described. In some embodiments, the drilling system may be used to obtain hydrocarbon fluid samples from a reservoir. Once samples have been obtained, they may be sent to a laboratory for pressure-volume-temperature testing to obtain properties used in the machine-learning predictor described herein.

In one or more embodiments, a drilling system may be used to drill a well based on hydrocarbon fluid properties predicted using the machine-learning predictor described herein. Systems such as the reservoir simulator 304, and the wellbore planning system 305 may all include or be implemented on one or more computer systems such as the one shown in FIG. 11.

FIG. 5 shows a drilling system 500 in accordance with one or more embodiments. The drilling system 500 may drill the wellbore along the planned wellbore path to access and produce the hydrocarbon reservoir 501. As shown in FIG. 5, a wellbore 502 following a wellbore trajectory 503 may be drilled by a drill bit 504 attached by a drill string 505 to a drill rig 506 located on the surface 507 of the earth. The drill rig 506 may include framework, such as a derrick 508 to hold drilling machinery. A top drive 509 sits at the top of the derrick 508 and provides clockwise torque via the drive shaft 510 to the drill string 505 in order to drill the wellbore 502. The drill string 505 may comprise a plurality of sections of drill pipe attached at the up-hole end to the drive shaft 510 and downhole to a bottom-hole assembly (BHA) 511. The BHA 511 may be composed of a plurality of sections of heavier drill pipe and one or more measurement-while-drilling (MWD) tools configured to measure drilling parameters, such as torque, weight-on-bit, drilling direction, temperature, etc., and one or more logging-while-drilling (LWD) tools configured to measure parameters of the rock surrounding the wellbore 502, such as electrical resistivity, density, sonic propagation velocities, gamma-ray emission, etc.

The wellbore 502 may traverse a plurality of overburden 512 layers and one or more cap-rock 513 layers to a hydrocarbon reservoir 501 within the subterranean region 514, and specifically to a drilling target 517 within the hydrocarbon reservoir 501. The wellbore trajectory 503 may be a curved or a straight trajectory. All or part of the wellbore trajectory 503 may be vertical, and some wellbore trajectory 503 may be deviated or have horizontal sections. One or more portions of the wellbore 502 may be cased with casing 515 in accordance with the wellbore plan.

To start drilling, or “spudding in” the well, the hoisting system lowers the drill string 505 suspended from the derrick 508 towards the planned surface location of the wellbore. An engine, such as a diesel engine, may be used to supply power to the top drive 509 to rotate the drill string 505. The weight of the drill string 505 combined with the rotational motion enables the drill bit 504 to bore the wellbore.

The near-surface is typically made up of loose or soft sediment or rock, so large diameter casing 515, e.g., “base pipe” or “conductor casing,” is often put in place while drilling to stabilize and isolate the wellbore. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface 507 of the earth.

Drilling may continue without any casing 515 once deeper, or more compact rock is reached. While drilling, a drilling mud system 516 may pump drilling mud from a mud tank on the surface 507 through the drill pipe. Drilling mud serves various purposes, including pressure equalization, removal of rock cuttings, and drill bit cooling and lubrication.

At planned depth intervals, drilling may be paused and the drill string 505 withdrawn from the wellbore. Sections of casing 515 may be connected and inserted and cemented into the wellbore. Casing string may be cemented in place by pumping cement and mud, separated by a “cementing plug,” from the surface 507 through the drill pipe. The cementing plug and drilling mud force the cement through the drill pipe and into the annular space between the casing and the wellbore wall. Once the cement cures, drilling may recommence. The drilling process is often performed in several stages. Therefore, the drilling and casing cycle may be repeated more than once, depending on the depth of the wellbore and the pressure on the wellbore walls from surrounding rock.

Due to the high pressures experienced by deep wellbores, a blowout preventer (BOP) may be installed at the wellhead to protect the rig and environment from unplanned oil or gas releases. As the wellbore becomes deeper, both successively smaller drill bits and casing string may be used. Drilling deviated or horizontal wellbores may require specialized drill bits or drill assemblies.

A drilling system 500 may be disposed at and communicate with other systems in the well environment. The drilling system 500 may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed, flow rate of the mud pumps and rate of penetration of the drilling operation. Each sensor may be positioned or configured to measure a desired physical stimulus. Drilling may be considered complete when a drilling target 517 is reached, or the presence of hydrocarbons is established.

In one or more embodiments, an input data vector containing reservoir conditions pertaining to an application hydrocarbon reservoir is obtained using a well logging tool.

A well logging tool is often attached to wireline and run downhole to measure a variety of reservoir properties in situ in the wellbore, or to retrieve samples and bring them to the surface to be measured. The tool type may vary based on the type of property being measured. For example, the logging tool may be a bottom-hole sampler, a transducer, a mechanical caliper, an ultrasonic tool, a thermocouple, a gamma ray source, or any other well logging tool known in the industry. The logging tool is used to produce a set of data versus well depth, also called a well log. Examples of a well log may be any commonly known in the oilfield industry, for example, an acoustic log, a caliper log, a density log, a pressure-temperature log, a resistivity log, a mud log, a gamma log, among others.

### Method for Predicting Hydrocarbon Fluid Properties Using Machine Learning

In one or more embodiments disclosed herein, a method for predicting hydrocarbon fluid properties consists of a training stage and a prediction stage, as well as optional extensions therein. In the training stage, the system is trained or calibrated using training datasets obtained from a fluid properties dataset. The fluid properties dataset includes data pairs obtained using a laboratory fluid properties analysis system. Accuracy of the predictor may be improved by also including data pairs obtained using physics-based simulation. Once trained, the trained predictor is used in the second stage to estimate unknown reservoir fluid properties.

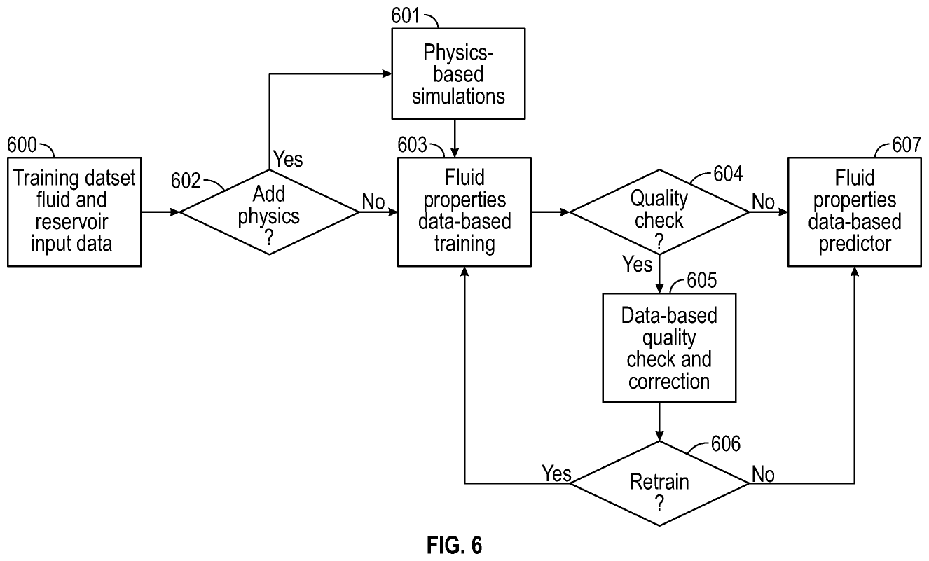

FIG. 6 shows a training workflow in accordance with one or more embodiments, in which a training dataset 600 (i.e., a fluid properties dataset) is obtained using a laboratory fluid properties analysis system and subsequently used to train a predictor, for example, an NN. Coarse estimations of hydrocarbon fluid properties can be predicted using physics-based simulations 601 and, if physics-based simulations are available 602Y, they can be integrated within a data-based framework 603 as additional fluid properties data. One approach is to integrate these models in the context of an NN to use their output as additional input to the network. If physics-based simulations are not available 602N, the training will be based only on the input data. Prior to use in the training workflow, input data undergoes a quality check. The training workflow includes an additional, optional quality check 604 to potentially improve training, where a quality check is performed on the high-fidelity estimate of the output vector. If the optional quality check is performed 604Y, a data-based quality check and correction 605 is performed, which may result in modifying the training data. If the input is changed, the predictor, in general, may need retraining 606Y. If no optional quality check is performed 604N or retraining is not needed 606N, a calibrated reservoir fluid property data-based trained predictor is outputted 607. In one or more embodiments, the trained ML predictor is a trained NN.

In some embodiments, the fluid properties dataset includes a plurality of data vectors. Some of the data vectors may be designated as inputs and some as outputs, each vector made up of hydrocarbon fluid properties at one temperature and pressure condition, including, but not limited to, reservoir conditions. The plurality of data vectors may include compositional analysis for the fluids of interest, and other related parameters such as hydrocarbon reservoir pressure and temperature. The plurality of data vectors may also include the target fluid properties to be estimated, where target properties may only be available for certain values of the compositional analysis data. Examples of these properties include, but are not limited to, bubble-point pressure, formation volume factor, mixture density, stock-tank density, and viscosity.

In one or more embodiments, physics-based simulations may be used to enhance the accuracy of training datasets. Traditionally, reservoir fluid properties can be approximated using physics-based simulations such as those based on equation-of-state (EOS) models. Typically, these models may require tuning of a number of their parameters, which is oftentimes a time-consuming and expert-dependent process. However, physics-based simulations may be used without tuning to generate coarse estimations of reservoir fluid properties.

A physics-based simulation uses laws of nature to predict physical properties. Physics-based simulations useful to embodiments disclosed herein may include equations of state (EOS). Equations of state are commonly used in thermodynamics to predict the physical properties of matter under a specified state (e.g., temperature, pressure, volume, etc.) from a measured property value under another state. Some examples of EOS are Soave-Redlich-Kwong EOS, Peng-Robinson EOS, Esmaeilzadeh-Roshanfekr EOS, Schmidt-Wenzel EOS, Patel-Teja EOS, among others.

A quality check may be used to ensure data integrity is maintained either as initial training data in the training stage, or during the prediction stage of the ML model. Quality-check processes can be divided into two categories based on their implementation using a closed loop or not. These two types can be utilized during both the training and prediction stages of the fluid-property estimation.

The first type of quality-check process is based on information related to the training data that is already known (for example, mathematical laws such as a mass balance, which requires the sum of concentration of a set of components in a mixture to equal 100%). The first type of quality-check may also rely on statistics of the training data, for example, as compared to similar training processes which have been performed.

The second type of quality-check process may be implemented by means of a closed loop that analyzes integrity of actual training data or prediction data. For example, in the training stage, prediction error (defined as the difference between an input property and an output property predicted from the training procedure) can be computed. The user may then define a specific threshold for which the prediction error must be below. This threshold value can be based on statistics from previous training processes related to the one of interest. If the prediction error is computed to be greater than the specific threshold defined by the user, the output property predicted from the training procedure is discarded and the user may opt to retrain the model accordingly. In the prediction stage, the second type of quality check described above relies on statistics gathered during the corresponding training stage.

The training procedure of FIG. 6, in one or more embodiments, is usually formulated as an optimization problem where the discrepancy between the output of the predictor for a set of inputs and the respective values of a reservoir fluid property of interest is minimized. Once an optimal solution to this problem is computed within satisfactory precision, and if the data used in the training is representative of future inputs to the system, it can be expected that the trained predictor will provide estimations which are satisfactorily accurate. “Optimal solution” as used herein is defined as a solution to an optimization problem. The term “satisfactory precision” with reference to an optimal solution as used herein is defined as a solution that satisfies a previously specified criterion for the termination of the optimization process (such as the discrepancy between prediction and fluid-property value for a set of inputs being smaller than a given tolerance).

Part of the training data is often selected randomly and not used in the mentioned optimization. That dataset, commonly known as the testing dataset, is used to validate the trained predictor. As the testing dataset has not been included in the training, it may provide information regarding how the trained predictor will behave for new data (i.e., data which are not included or are essentially different from the training data). Optimization is presented in contrast to other heuristic approaches, such as trial and error. In a trial and error training approach, the user selects a number of calibration parameters, which are modified, for example, by adding and subtracting certain perturbation values. The testing dataset is used for validation purposes. This can be achieved, for example, by computing a measure of discrepancy between the input data for the testing dataset and the corresponding property value of interest. The measure computed may, by itself, and also when compared to the same measure applied to the training dataset, provide information of general performance of the trained predictor. Note that this assessment relies on how well the testing dataset represents the new data that may be input to the predictor (thus, if the testing dataset fails to include data not captured in the training dataset and that could possibly be input to the predictor, the measure computed for the testing dataset may give a wrong impression of the accuracy of the predictor for new data not seen before).

The data-based framework may include a stage where the data is subjected to a number of mathematical transformations, such as a logarithmic function (in this case for input data that are positive numbers), to possibly improve the performance (these transformations allow, for example, emphasizing certain ranges of values of the input parameters used in the training stage). Mathematical transformations can be considered “feature engineering,” that is, including domain knowledge in order to improve accuracy (or other related metrics) in the training stage and subsequent prediction stage. In the flow diagram of FIG. 6, the transformations may be part of the training or directly applied to the training dataset 600.

In some embodiments, in certain scenarios, such as when the amount of input data is small, data relevant for the training may be missed due to random selection for the testing dataset. In these scenarios, the training workflow in FIG. 6 can be repeated multiple times with different choices for the testing dataset. Consequently, several predictors, referred to herein as sub-predictors for the estimation of a given reservoir fluid property, will be trained. By combining trained sub-predictors for each of a plurality of training datasets, a predictor may be trained to determine an estimate of a fluid property with higher precision than the individual sub-predictors. The output from these trained sub-predictors can be aggregated so that the estimation is not, generally, a single number but a set of numbers. This set of numbers can be, in turn, used to infer a probability distribution associated with an uncertainty metric of the estimation. The procedure to generate sub-predictors may be used when certain statistical measures, for example, the percentiles P10, P50 and P90, when computed for the entire dataset differ noticeably from those obtained from the training dataset. If the difference for any of the selected percentiles is larger than a prespecified tolerance, the procedure to generate sub-predictors may be used. The rationale behind this criterion is that the training dataset should be similar statistically to the entire dataset. In any event, the procedure to generate sub-predictors may be always considered if additional robustness is needed for the predictor.

One or more embodiments herein relate to training the predictor to quantify uncertainty of the predicted reservoir fluid properties. As used herein, “uncertainty quantification refers” to computing the prediction for a property, in general, as a probability distribution (rather than as a single value). This quantification process includes propagating uncertainty from the input parameters to the prediction (input data may be, in general, uncertain). Uncertainty of the predicted properties can be achieved through the estimation of these properties for arbitrary values of a number of input parameters within certain, relatively large, validity ranges. The workflow in FIG. 6, through the running of multiple training processes, allows the handling of uncertainty in the input. Each of these processes is trained using a random realization of the input data consistent with the quantified uncertainty. For example, the output of compositional analysis may be given with measurement tolerances; thus, for a given input value equal to x with a measurement tolerance of y %, a particular training process may consider a random value for that input selected in the interval [x−xy/100, x+xy/100]. When input uncertainty is treated as just described, multiple trained predictors will be outputted, which can be used to determine a probability distribution that corresponds to the fluid property of interest.

In one or more embodiments, the training workflow described in FIG. 6 may also be used to rank input parameters based on a ranking error metric. An example of ranking error metric is the coefficient of determination R² for a fluid property and the prediction for that property from the training procedure, computed for the testing dataset. The following procedure may be used to determine a ranking of input parameters based on the error metric. Each parameter is subjected to the training procedure illustrated in FIG. 6, one at a time. After the predictor is trained with the first parameter, the training process described above is used to train the predictor based on a second parameter. The procedure is repeated for a third parameter, a fourth parameter, and so on for all of the parameters. The parameter that yields the lowest error metric (i.e., has the highest contribution in terms of reduction of prediction error) is ranked first. Thus, a parameter being highest in the ranking can be interpreted as the parameter, out of all the parameters to be ranked, having the greatest influence on the output. Then, the parameter with the lowest error metric which is ranked first is paired with an arbitrary second parameter and the training process in FIG. 6 as described above is repeated for the parameter which is ranked first and the arbitrary second parameter, combined, and an error metric is calculated for the pair. The procedure is repeated for a third parameter, a fourth parameter, and so on until all of the parameters have been combined (one at a time) with the parameter with the lowest error metric which is ranked first, subjected to the training procedure in FIG. 6, and calculated the error metric for each pair. The combination of parameters that minimizes the error metric is ranked second, and so on until all of the parameters have been ranked based on the error metric. If the error metric associated with a subset of input parameters is less than or equal to the error metric which corresponds to using all parameters from the training dataset simultaneously in the training procedure, then the training of the predictor may be based on the subset and may yield more accurate results than when the predictor is trained using all parameters from the training dataset simultaneously in the training procedure.

Although, in theory, the optimized error metric when all input parameters are considered should be smaller than when a subset of parameters is used, in practice, due to the higher complexity of a problem with more parameters (e.g., presence of a larger number of local optima), this may not be the case (because, for example, in the first case, the optimal search could converge to a suboptimal solution). Note that the complexity of a training problem, in general, increases with the number of parameters, and, consequently, problems with a small number of parameters can be solved more accurately than those with a larger number of parameters (especially if available resources are limited). Note that the ranking procedure can be terminated once the addition of the best parameter out of the parameters not ranked yet (best as described above in the procedure) does not bring improvement in terms of the error metric. It can then be expected that parameters not ranked yet may not have significant impact on the output and, consistent with that, they can be ignored in the prediction.

In general, the selection of a subset of input parameters aims at having a better (more accurate or more reliable) trained predictor. The incremental training may be often a computationally efficient strategy to optimize the selection of input parameters. One way to identify parameters that contribute more to the prediction may be the application of Shapley values. However, determining the Shapley values is computationally more expensive than the procedure described above because all combination of parameters that do not include a given parameter have to be considered to obtain the Shapley value that corresponds to that parameter (and that requires performing the associated training processes). In any event, the ranking procedure presented in embodiments herein may be modified as follows to incorporate Shapley values. First, compute the Shapley value for each parameter and select the parameter with highest Shapley value. Thereafter, obtain the Shapley values for the remaining parameters and include the previously selected parameter in all subsets of parameters considered in the computation of the Shapley values. After that, choose the parameter with highest Shapley value and proceed as for the first parameter but with the two parameters selected, and iterate until the addition of a new parameter does not bring improvement to the prediction or until all parameters have been selected. As explained earlier, the process may identify a subset of parameters whose performance is better than for the entire set (thus, ranking would make sense only for this subset of parameters).

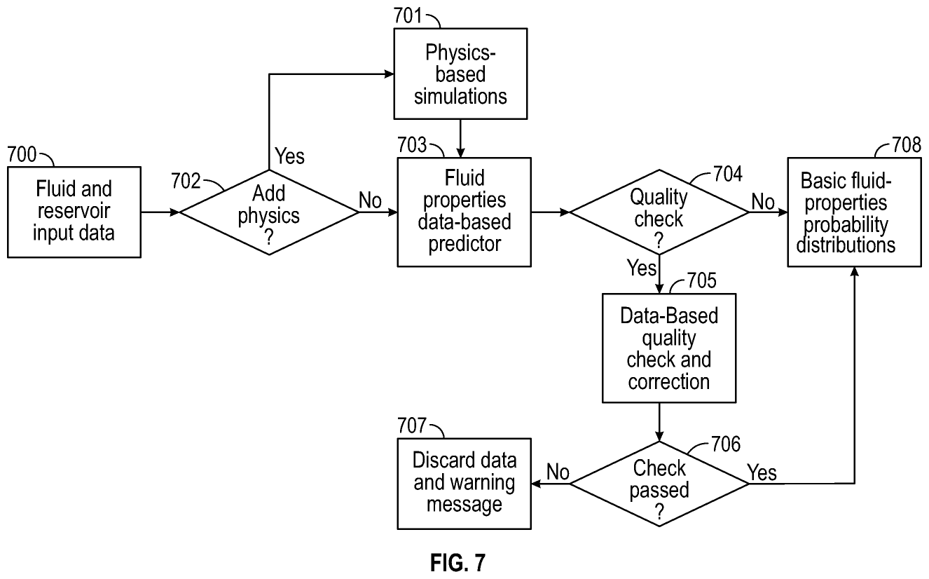

FIG. 7 shows a prediction workflow in accordance with one or more embodiments, wherein a predictor is used to determine hydrocarbon fluid properties pertaining to the application hydrocarbon reservoir at multiple conditions, including conditions of the application hydrocarbon reservoir, from fluid properties pertaining to the application hydrocarbon reservoir at multiple conditions in a laboratory. The input data 701 for the prediction, which may have been subjected to a number of quality checks, unlike in the training stage, does not include known values for reservoir fluid properties (since those are the target in the estimation). A physics-based simulation 701 will be included 702Y if it was included in the training stage, or it will not be included 702N if it was not included in the training stage. If physics-based simulation is considered in the training stage, it is used as additional input to the predictor to be trained. As a consequence, when applying the predictor to generate an estimate, all inputs to the predictor are required, including the one associated with physics-based simulation. The trained data-based trained ML model 703 is then used to generate estimations for the input data. The same mathematical transformations applied in the training stage, if any, may also be considered in the prediction.

Keeping with FIG. 7, in one or more embodiments, as in the training stage, there is an option to perform a data-based quality check 704Y. This quality check 705 may rely on, for example, comparing the predicted fluid property and a statistical analysis of the input data vectors and the output data vectors (such as percentiles). If the quality check 705 is not passed 706N, the prediction is deemed unreliable, the corresponding input data is discarded, and a warning message is generated 707. Otherwise, if the quality check 705 is passed 706Y or not performed 704N, the reservoir fluid properties pertaining to the application hydrocarbon reservoir are outputted 708 (note that predictions deemed unreliable are not part of the output).

In some embodiments, the outputted property from FIG. 7 for a given input value and fluid property consists of multiple values, from which a probability distribution can be inferred. Multiple probability intervals can be obtained from that distribution, for example, the interquartile range, i.e., the difference between the first and third quartiles. (Note, the first and third quartiles indicate values for which the probability of being smaller than or equal to this value is 25% and 75%, respectively.) Providing the output as a probabilistic prediction gives additional information of the uncertainty of the prediction of the target properties. This, within an uncertainty-analysis framework, can be leveraged to evaluate the effect of potential variation in target properties and make more robust decisions. For example, extreme values of the distribution may quantify the range of profitability for the development of a given hydrocarbon field, and, according to that information, help decide between multiple development plans.

In some embodiments, the method for predicting hydrocarbon fluid properties described above may be extended in the following two ways. In the first extension, input data may be segregated into a number of subsets. In this case, independent training for each individual subset leads to a set of corresponding trained predictors that, in principle and if enough input data is available to calibrate each predictor adequately, are more precise than a single trained predictor calibrated with all the input data (indeed, prediction based on a single predictor is a special case of the use of many predictors). Second, the trained predictor described above is combined with well-known statistical correlations. These correlations are prediction models that have been already calibrated with different types and amounts of data. The inclusion of existing correlations in predictive models can be thus seen as a way to augment the data considered in the model training. Trained predictors based on a larger amount of data can be expected to be more precise.

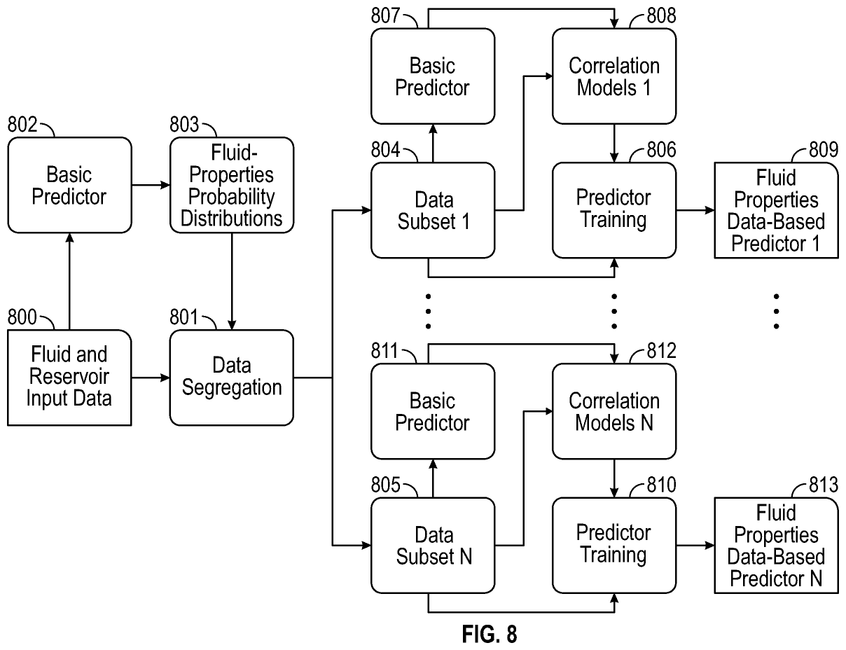

FIG. 8 shows a training workflow with data segregation and correlation models in accordance with one or more embodiments. The input data 800 is the same as in the training procedure as described in FIG. 6. The segregation stage 801 is based on this input dataset 800 and on estimates of hydrocarbon fluid properties. For this estimate, a predictor 802, whose output is hydrocarbon fluid properties at multiple conditions, including but not limited to, reservoir conditions that relate to the data segregation 803, is used. Training of the predictor 802 can be achieved using the workflow presented in FIG. 6. The segregation 801 can be based, for example, on the linear combinations of several concentrations of hydrocarbon components or on fluid properties falling into a number of intervals or bins. The input data 800 is partitioned into a number (N) of subsets 804, 805, which are subjected to individual training. The training for the first subset 806, which is representative of the training processes for the remaining subsets, also follows the scheme described in FIG. 6 and includes, as additional input, the output of one or more correlation models 808. Data-based prediction 807 can be used to estimate the inputs of the correlation models 808 that are not available.

Keeping with FIG. 8, the output of the training of the first subset is a trained predictor 809. This trained predictor 809 will be applied to input data 800 that, according to a segregation procedure used in the training process of FIG. 8, is classified together with a first subset of data 804. Training proceeds in that same manner for the other subsets until training for subset N 805 is completed and the corresponding trained predictor is outputted 810, 811, 812, 813. A segregation parameter or parameters, for example, the number of bins used and the corresponding intervals, may be determined through optimization. In this optimization, the segregation parameters would be an optimization variable or variables and an error or performance metric that quantifies how segregation improves with respect to when no segregation is considered would be the optimization cost or objective function.

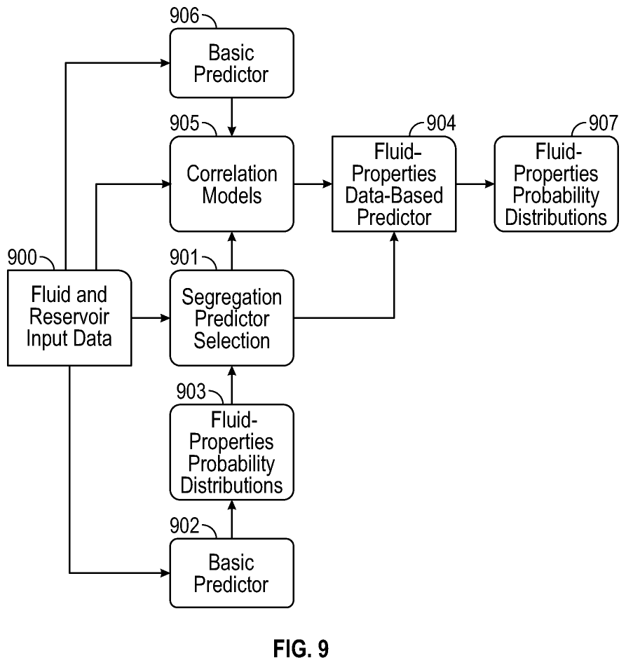

FIG. 9 shows a prediction workflow with data segregation and correlation models in accordance with one or more embodiments. The segregation procedure 901 is the same as the one considered in the training stage and is based on the input data and estimations of hydrocarbon fluid properties at multiple conditions, including at reservoir conditions. A previously calibrated trained predictor 902 outputs the properties needed in the segregation 903, which allows selection of the data-based trained predictor 904. This trained predictor is combined with a number of statistical-correlation models 905, which are defined for a number of available input parameters and estimations determined through data-based prediction 906. The output of the trained predictor for each hydrocarbon fluid properties at multiple conditions, including at reservoir conditions 907, as already discussed previously, consists of multiple values, from which a probability distribution can be inferred.

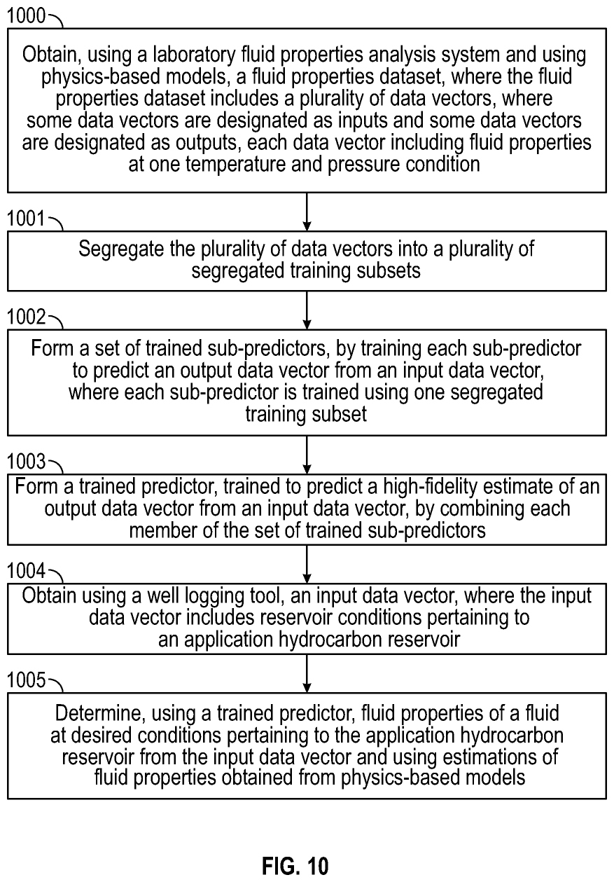

FIG. 10 depicts a flowchart in accordance with one or more embodiments disclosed herein. In step 1000, a fluid properties dataset may be obtained, using a laboratory fluid properties analysis system and using physics-based models. The fluid properties dataset includes a plurality of data vectors, where some data vectors are designated as inputs and some data vectors are designated as outputs, each data vector including fluid properties at one temperature and pressure condition. In some embodiments, obtaining the fluid properties dataset further includes obtaining the plurality of data vectors using a correlation model. In some embodiments, the fluid properties dataset includes a bubble-point pressure.

Keeping with FIG. 10, in step 1001, the plurality of data vectors may be segregated into a plurality of segregated training subsets. In some embodiments, the plurality of data vectors may be segregated by determining a plurality of segregation parameters by optimizing, using a cost or objective function, a segregation performance metric, where the segregation performance metric includes a quantification of improving the method of training a predictor when segregating the plurality of data vectors with respect to when the plurality of data vectors is not segregated.

Keeping with FIG. 10, in step 1002, a set of trained sub-predictors may be formed by training each sub-predictor to predict an output data vector from an input data vector, wherein each sub-predictor is trained using one segregated training subset. In some embodiments, the predictor may be further trained to predict hydrocarbon-fluid properties by training the predictor to rank components of each of the plurality of input data vectors and select an improved subset of the components, where the selected components of the improved subset have a lower ranking error metric than unselected components of each of the plurality of input data vectors. The components comprise input fluid properties at one temperature and pressure condition based on a ranking error metric. The ranking may improve accuracy of the high-fidelity estimate of the output vector.

The high-fidelity estimate obtained by combining the plurality of trained sub-predictors has been shown to greater reliability, i.e., accuracy, precision and repeatability, than the estimate provided by any one of the trained sub-predictors. In some embodiments, training the predictor to predict hydrocarbon-fluid properties may further include performing a quality-check on the high-fidelity estimate of the output vector and where the set of trained sub-predictors are corrected based on a result of the quality-check.

Keeping with FIG. 10, in step 1003, a trained predictor may be formed, where the trained predictor is trained to predict a high-fidelity estimate of an output data vector from an input data vector, by combining each member of the set of trained sub-predictors. In some embodiments, the high-fidelity estimate includes an uncertainty metric, and the uncertainty metric may include a confidence interval. In some embodiments, the set of trained sub-predictors includes a trained neural network.

Keeping with FIG. 10, in step 1004, an input data vector may be obtained using a well logging tool, where the input data vector includes reservoir conditions pertaining to an application hydrocarbon reservoir. In some embodiments, the fluid properties include a bubble-point pressure.

Keeping with FIG. 10, in step 1005, fluid properties of a fluid at desired conditions pertaining to the application hydrocarbon reservoir may be determined, using a trained predictor, from the input data vector and using estimations of fluid properties obtained from physics-based models. In some embodiments, determining fluid properties may further include combining the trained predictor with a correlation model. In some embodiments, determining, using a trained predictor, fluid properties of a fluid further may also include segregating the input data vector and estimations of fluid properties obtained from physics-based models into segregated input data. In some embodiments, determining, using a trained predictor, fluid properties of a fluid sample may further include quantification of uncertainty. In some embodiments, the method further includes simulating, using a reservoir simulator, simulated fluid flow within the application hydrocarbon reservoir. In some embodiments, the method further includes identifying a drilling target based, at least in part, on the simulated fluid flow. In some embodiments, the method further includes planning, using a wellbore planning system, a planned wellbore trajectory to reach the drilling target. In some embodiments, the method further includes drilling, using a drilling system, a wellbore guided by the planned wellbore trajectory.

FIG. 11 depicts a block diagram of a computer system used to provide computational functionalities associated with described networks, methods, functions, processes, flows, and procedures as described in this disclosure, according to one or more embodiments. The illustrated computer 1102 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 1102 may include a computer that includes an input device, such as a keypad, keyboard, touch screen, or other device that can accept user information, and an output device that conveys information associated with the operation of the computer 1102, including digital data, visual, or audio information (or a combination of information), or a GUI.

The computer 1102 can serve in a role as a client, network component, a server, a database or other persistency, or any other component (or a combination of roles) of a computer system for performing the subject matter described in the instant disclosure. The illustrated computer 1102 is communicably coupled with a network 1130. In some implementations, one or more components of the computer 1102 may be configured to operate within environments, including cloud-computing-based, local, global, or other environment (or a combination of environments).

At a high level, the computer 1102 is an electronic computing device operable to receive, transmit, process, store, or manage data and information associated with the described subject matter. According to some implementations, the computer 1102 may also include or be communicably coupled with an application server, e-mail server, web server, caching server, streaming data server, business intelligence (BI) server, or other server (or a combination of servers).

The computer 1102 can receive requests over network 1130 from a client application (for example, executing on another computer 1102) and responding to the received requests by processing the said requests in an appropriate software application. In addition, requests may also be sent to the computer 1102 from internal users (for example, from a command console or by other appropriate access method), external or third-parties, other automated applications, as well as any other appropriate entities, individuals, systems, or computers.

Each of the components of the computer 1102 can communicate using a system bus 1103. In some implementations, any or all of the components of the computer 1102, both hardware or software (or a combination of hardware and software), may interface with each other or the interface 1104 (or a combination of both) over the system bus 1103 using an application programming interface (API) 1112 or a service layer 1113 (or a combination of the API 1112 and service layer 1113). The API 1112 may include specifications for routines, data structures, and object classes. The API 1112 may be either computer-language independent or dependent and refer to a complete interface, a single function, or even a set of APIs. The service layer 1113 provides software services to the computer 1102 or other components (whether or not illustrated) that are communicably coupled to the computer 1102. The functionality of the computer 1102 may be accessible for all service consumers using this service layer. Software services, such as those provided by the service layer 1113, provide reusable, defined business functionalities through a defined interface. For example, the interface may be software written in JAVA, C++, or other suitable language providing data in extensible markup language (XML) format or another suitable format. While illustrated as an integrated component of the computer 1102, alternative implementations may illustrate the API 1112 or the service layer 1113 as stand-alone components in relation to other components of the computer 1102 or other components (whether or not illustrated) that are communicably coupled to the computer 1102. Moreover, any or all parts of the API 1112 or the service layer 1113 may be implemented as child or sub-modules of another software module, enterprise application, or hardware module without departing from the scope of this disclosure.

The computer 1102 includes an interface 1104. Although illustrated as a single interface 1104 in FIG. 11, two or more interfaces 1104 may be used according to particular needs, desires, or particular implementations of the computer 1102. The interface 1104 is used by the computer 1102 for communicating with other systems in a distributed environment that are connected to the network 1130. Generally, the interface 1104 includes logic encoded in software or hardware (or a combination of software and hardware) and operable to communicate with the network 1130. More specifically, the interface 1104 may include software supporting one or more communication protocols associated with communications such that the network 1130 or interface's hardware is operable to communicate physical signals within and outside of the illustrated computer 1102.

The computer 1102 includes at least one computer processor 1105. Although illustrated as a single computer processor 1105 in FIG. 11, two or more processors may be used according to particular needs, desires, or particular implementations of the computer 1102. Generally, the computer processor 1105 executes instructions and manipulates data to perform the operations of the computer 1102 and any networks, methods, functions, processes, flows, and procedures as described in the instant disclosure.

The computer 1102 also includes a memory 1106 that holds data for the computer 1102 or other components (or a combination of both) that can be connected to the network 1130. For example, memory 1106 can be a database storing data consistent with this disclosure. Although illustrated as a single memory 1106 in FIG. 11, two or more memories may be used according to particular needs, desires, or particular implementations of the computer 1102 and the described functionality. While memory 1106 is illustrated as an integral component of the computer 1102, in alternative implementations, memory 1106 can be external to the computer 1102.

The application 1107 is an algorithmic software engine providing functionality according to particular needs, desires, or particular implementations of the computer 1102, particularly with respect to functionality described in this disclosure. For example, application 1107 can serve as one or more components, modules, applications, etc. Further, although illustrated as a single application 1107, the application 1107 may be implemented as multiple applications 1107 on the computer 1102. In addition, although illustrated as integral to the computer 1102, in alternative implementations, the application 1107 can be external to the computer 1102.

There may be any number of computers 1102 associated with, or external to, a computer system containing computer 1102, wherein each computer 1102 communicates over network 1130. Further, the term “client,” “user,” and other appropriate terminology may be used interchangeably as appropriate without departing from the scope of this disclosure. Moreover, this disclosure contemplates that many users may use one computer 1102, or that one user may use multiple computers 1102.

### EXAMPLES

EXAMPLE 1 describes how the method for predicting hydrocarbon fluid properties of one or more embodiments has been validated with real data. The fluid properties of interest are bubble-point pressure, gas-oil ratio (GOR), formation volume factor and American Petroleum Institute (API) density. The input parameters are data from compositional analysis and reservoir temperature. NNs are used for the data-based prediction stage and neither segregation nor hybridization is included. The networks are calibrated 100 times using the respective 100 random datasets for training. Prediction is determined by computing the 50th percentile (median) with the 100 networks and is compared with two physics-based simulations, namely, the Soave-Redlich-Kwong (SRK) and the Peng-Robinson (PR) equations of state (both with Péneloux volume translation). The error metric considered is the mean absolute percentage error (MAPE) for the samples in the testing dataset and averaged over the 100 runs. The MAPEs associated with the estimation via the NN, SRK and PR models for bubble-point pressure are 9.45%, 21.65% and 13.59%, for GOR are 16.64%, 17.76% and 15.93%, for formation volume factor are 1.08%, 1.88% and 1.94%, and for API density are 3.13%, 5.42% and 4.70%. In all cases, except GOR, the MAPEs for the data-based method are smaller for the NN predictor. Note that the physics-based simulations have a number of parameters that can be used to calibrate these models. In any event, the calibrated models can be hybridized with the NNs, as described above in the FIGS. 6 and 7, to improve performance with respect to the individual components (the input dataset can be segregated as well to reduce the error further). The dataset selected for the comparison corresponds to samples for which the reservoir temperature is almost constant. The NNs were trained using datasets where the reservoir temperature varies so the results obtained in the comparison are expected to be representative of these more general scenarios.

EXAMPLE 2 describes how a statistical correlation for the estimation of bubble-point pressure, Standing's correlation, was compared with the implementation of the method for predicting hydrocarbon fluid properties disclosed in one or more embodiments herein. The target property of the predictor is bubble-point pressure. Input parameters are data from compositional analysis and reservoir temperature, NNs are used for the data-based prediction stage and, initially, neither segregation nor hybridization is included. The estimation is computed with only one network but is repeated 100 times (in each of these 100 runs, the respective datasets for training and testing are selected randomly). The error metric is the MAPE computed for the samples in the testing dataset and averaged over the 100 runs. Standing's correlation has as input other fluid properties than bubble-point pressure, which very often in practice are not known. In this validation, these properties are estimated via NNs. The average MAPE associated with Standing's correlation is 10.75% and with NN is 8.05%. This latter error is smaller than the one for the data-based method in the first validation example because the datasets were different. If the prediction computed with Standing's correlation is considered as additional input in the NN, the average MAPE obtained is 7.30%.

EXAMPLE 3 describes how the method for predicting hydrocarbon fluid properties of one or more embodiments disclosed herein is improved by the optional extension of data segregation. The target property is bubble-point pressure, the input parameters are data from compositional analysis and reservoir temperature, and NNs without model hybridization are chosen for data-based prediction. The estimation relies on a single network and is repeated 100 times (the respective training and testing datasets are selected randomly). The error metric is the MAPE determined for the samples in the testing dataset and averaged over all the runs. Segregation is based on the value of one of the compositional-analysis outputs. Two datasets are obtained according to the value of that output being smaller or not than a given threshold. The threshold was determined as indicated earlier through optimization, where the average MAPE of the aggregated testing datasets is minimized. The MAPE associated with the segregation is 8.24% while without segregation is 10.60%.

Examples 1-3 apply the prediction described in one or more embodiments disclosed hereinto real data. EXAMPLE 1 shows that the accuracy of the prediction for certain fluid properties is acceptable for practical applications. EXAMPLE 2 illustrates that the inclusion of correlation models in the predictor (as indicated in FIG. 8) yields improvement with respect to using the predictor without these models. Finally, EXAMPLE 3 demonstrates that using data segregation (as represented in FIG. 8) can be beneficial. In EXAMPLES 2-3, the “previous” models would be the predictor without correlation models and data segregation, respectively.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A computer-implemented method of training a predictor to predict hydrocarbon-fluid properties, comprising:
obtaining, using a laboratory fluid properties analysis system and using physics-based models, a fluid properties dataset, wherein the fluid properties dataset comprises a plurality of data vectors, wherein some data vectors are designated as inputs and some data vectors are designated as outputs, each data vector comprising fluid properties at one temperature and pressure condition;
segregating the plurality of data vectors into a plurality of segregated training subsets;
forming a set of trained sub-predictors, by training each sub-predictor to predict an output data vector from an input data vector, wherein each sub-predictor is trained using one segregated training subset; and
forming a trained predictor, trained to predict a high-fidelity estimate of an output data vector from an input data vector, by combining each member of the set of trained sub-predictors.

2. The method of claim 1, wherein obtaining the fluid properties dataset further comprises obtaining the plurality of data vectors using a correlation model.

3. The method of claim 1, wherein segregating the plurality of data vectors into the plurality of segregated training subsets comprises determining a plurality of segregation parameters by optimizing, using a cost or objective function, a segregation performance metric, wherein the segregation performance metric comprises a quantification of improving the method of training a predictor when segregating the plurality of data vectors with respect to when the plurality of data vectors are not segregated.

4. The method of claim 1, wherein training the predictor to predict hydrocarbon-fluid properties further comprises training the predictor to rank components of each of the plurality of input data vectors, wherein the components comprise input fluid properties at one temperature and pressure condition based on a ranking error metric and select an improved subset of the components, wherein the selected components of the improved subset have a lower ranking error metric than unselected components of each of the plurality of input data vectors, to improve accuracy of the high-fidelity estimate of the output vector.

5. The method of claim 1, wherein training the predictor to predict hydrocarbon-fluid properties further comprises performing a quality-check on the high-fidelity estimate of the output vector and wherein the set of trained sub-predictors are corrected based on a result of the quality-check.

6. The method of claim 1, wherein the high-fidelity estimate comprises an uncertainty metric, and wherein the uncertainty metric comprises a confidence interval.

7. The method of claim 1, wherein the set of trained sub-predictors comprises a trained neural network.

8. The method of claim 1, wherein the fluid properties dataset comprises a bubble-point pressure.

9. A method for predicting hydrocarbon-fluid properties at desired conditions, comprising:
obtaining, using a well logging tool, an input data vector, wherein the input data vector comprises reservoir conditions pertaining to an application hydrocarbon reservoir; and
determining, using a trained predictor, fluid properties of a fluid at desired conditions pertaining to the application hydrocarbon reservoir from the input data vector and using estimations of fluid properties obtained from physics-based models.

10. The method of claim 9, wherein determining fluid properties further comprises combining the trained predictor with a correlation model.

11. The method of claim 9, wherein determining, using a trained predictor, fluid properties of a fluid further comprises segregating the input data vector and estimations of fluid properties obtained from physics-based models into segregated input data.

12. The method of claim 9, wherein determining, using a trained predictor, fluid properties of a fluid sample further comprises quantification of uncertainty.

13. The method of claim 9, wherein the fluid properties comprise a bubble-point pressure.

14. The method of claim 9, further comprising:
simulating, using a reservoir simulator, simulated fluid flow within the application hydrocarbon reservoir; and
identifying a drilling target based, at least in part, on the simulated fluid flow.

15. The method of claim 14, further comprising:
planning, using a wellbore planning system, a planned wellbore trajectory to reach the drilling target; and
drilling, using a drilling system, a wellbore guided by the planned wellbore trajectory.

16. A system, comprising:
a well logging tool, configured to measure reservoir conditions pertaining to an application hydrocarbon reservoir;
a laboratory fluid properties analysis system, configured to measure an application dataset pertaining to the application hydrocarbon reservoir, wherein the application dataset comprises reservoir fluid properties at multiple temperature and pressure conditions;
a trained predictor, configured to determine fluid properties of a fluid sample at desired conditions pertaining to the application hydrocarbon reservoir from a fluid properties dataset,
wherein the fluid properties dataset comprises a plurality of data vectors, wherein some data vectors are designated as inputs and some data vectors are designated as outputs, each data vector comprising fluid properties at one temperature and pressure condition obtained using a laboratory fluid properties analysis system and using physics-based models;
a reservoir simulator, configured to simulate a fluid flow within the application hydrocarbon reservoir and identify a drilling target based, at least in part, on the simulated fluid flow;
a wellbore planning system, configured to plan a planned wellbore trajectory to reach the drilling target; and
a drilling system, configured to drill a wellbore guided by the planned wellbore trajectory.

17. The system of claim 16, wherein obtaining a fluid properties dataset further comprises obtaining a plurality of data vectors using a correlation model.

18. The system of claim 16, wherein the trained predictor is further configured to determine fluid properties of a fluid by segregating the input data vector and estimations of fluid properties obtained from physics-based models into segregated input data.

19. The system of claim 16, wherein the trained predictor is further configured to perform a quality check by comparing the fluid properties to a statistical analysis of the input data vectors and the output data vectors, wherein if the quality check is not passed, the output vector is deemed unreliable, an input data vector corresponding to the output data vector is discarded, and a warning message is generated.

20. The system of claim 16, wherein the trained predictor is further configured to determine an uncertainty metric.
